(19) United States
(12) Patent Application Publication
(10) Pub. No.: US 2016/0120619 A1
(43) Pub. Date: May 5, 2016

(54) Orthotic Device

(71) Applicant: Brian K. Bons, Parkland, FL (US)

(72) Inventor: Brian K. Bons, Parkland, FL (US)

(21) Appl. No.: 14/526,668

(22) Filed: Oct. 29, 2014

(51) Int. Cl. A61C 7/08

(52) U.S. Cl. CPC A61C 7/08; A61C 2201/00

(57) ABSTRACT

Orthotic devices are provided that reduce or eliminate the manifestation of certain involuntary movements. Through the configuration and/or composition of the devices of the present invention, persons with certain neurologic disorders and neuro-psych disorders such as Tourette Syndrome and Chronic Tic Disorder may experience a reduction in involuntary movements and urges.

### FIELD OF THE INVENTION

The present invention relates to the field of orthotics for use in an oral cavity in order to reduce or to eliminate involuntary movements.

### BACKGROUND OF THE INVENTION

Among the manifestations of certain neurologic disorders and neuro-psychological disorders, such as Tourette Syndrome and Chronic Tic Disorder, are involuntary body movements. These movements may, for example, be in the form of tics, which are involuntary muscle contractions that may result in blinking, coughing, sniffing, shoulder shrugging, neck stretching, throat clearing, facial twitching and/or vocalizations.

The causes of many of these disorders are not well-understood, but one element that is common to most, if not all of them, is the involvement of the temporomandibular joint (“TMJ”). The TMJ is formed at the situs where the mandible (the lower jaw) connects to the temporal bone of the skull. Connection of the mandible to the skull is via a series of tendons, ligaments and muscles.

At the TMJ, the mandible is capable of rotating within the fossa of the joint, and the mandible has the unique ability to translate down the articulate eminence of the temporal bone when the space between the posterior opposing teeth exceeds four or five millimeters. Thus, there is the potential for significant movement of the jaw in a plurality of directions.

Surrounding the TMJ is the auriculotemporal nerve. This nerve provides the means for the main sensory signals from the TMJ to the brain, and signals from the auriculotemporal nerve, through a complex pathway, can lead to the initiation of involuntary movements, including but not limited to movements in and around the TMJ. Therefore, there is an opportunity to modulate, if not eliminate undesirable movements by controlling the signals that travel through both this nerve and other nerves that are part of the same or related signaling pathways.

The inventor has appreciated that because of the importance of the TMJ in movement disorders, there is a possibility of developing an oral orthotic that affects signaling of or by the auriculotemporal nerve. However, designing an oral orthotic presents a number of challenges, including, but not limited to the constraints on the size of the oral cavity, the need to be able to withstand the force exerted by the jaw, the need for bio-compatibility, the need for a person to be able to breathe through his or her oral cavity, the need to accommodate both the presence and movement of a person's tongue, and the goal of configuring a device that when in use allows a person to be understood by others while speaking.

Unfortunately, to date no one has developed an orthotic that is sufficiently beneficial in reducing the frequency and/or intensity of undesirable movements such as tics, while addressing a sufficient number of the aforementioned challenges. Various embodiments of the present invention are directed to overcoming one or more of the aforementioned challenges while reducing the frequency and/or intensity of undesirable involuntary movements.

### SUMMARY OF THE INVENTION

The present invention provides devices and methods for modulating certain symptoms of neurologic disorders and neuro-psychological disorders. Through the use of these devices, a person who is affected by one or both of these disorders, and/or any one or more other disorders that are associated with undesirable involuntary movements, may reduce the frequency and/or severity of these movements.

According to one embodiment, the present invention provides an orthotic device comprising: (a) a first layer, wherein the first layer comprises a cushioning material and is configured to engage the infrabulge of a plurality of teeth of one of an upper set of teeth or a lower set of teeth by mechanical retention; (b) a second layer, wherein the second layer forms a protective coating and is chemically bonded to the first layer; and (c) an arched trapezium, wherein the second layer forms a platform for the arched trapezium. Preferably, the device comprises two arched trapeziums, each of which is in the form of a block.

According to a second embodiment, the present invention provides an orthotic device comprising: (a) a dental guard, wherein the dental guard is configured to retain association with a person's lower set of teeth or upper set of teeth by exerting a mechanical force; and (b) a first block and a second block, wherein each of the first block and the second block is comprised of poly methyl-methacrylate and the first block is affixed to the dental guard at a location that corresponds to the location from a right premolar to a right molar and the second block is affixed to the dental guard at a location that corresponds to a location from a left premolar to a left molar.

According to a third embodiment, the present invention is directed to a method for creating neuro stimulation comprising exerting force on an orthotic device of the present invention, wherein the orthotic device is in a subject's oral cavity and the subject causes an occlusal surface to exert pressure on one or more blocks of the device. As used herein, the terms “user” and “subject” are used interchangeably and refer to a person who has a device in his or her oral cavity, or for whom a device of the present invention is being designed or has been designed. Through various embodiments of the present invention one can stimulate sensory fibers in or near the TMJ, e.g., at a joint capsule, thereby creating a shutoff mechanism in a person's brain to prevent motor nerves from firing or to reduce the frequency and/or intensity at which they fire.

In some embodiments, the devices of the present invention comprise one, two or more blocks, the height of which can be adjusted by adding or subtracting material on the occlusal surface, which corresponds to the upper surface of a block. The ability to modify the vertical dimension of the devices of the present invention and to create a positive seat for the opposing occlusion provides an opportunity to mitigate the clinical manifestations of a neurologic or a neuro-psychological disorder. In some embodiments, when the device is in use, it adjusts the position of the mandible of a subject in order to relieve pressure exerted on one or more nerves and/or on tissue in and around the TMJ. Thus, by configuring and/or adjusting the orthotic and having the ability to sculpt the orthotic, one may efficiently and effectively mitigate physical manifestations such as tic severity and/or frequency.

### BRIEF DESCRIPTION OF THE FIGURES

FIG. 1 is a representation of an orthotic device of the present invention.

FIG. 2 is a representation of another view of an orthotic device of the present invention.

FIG. 3 is a representation of a close-up view of an arched trapezium of an orthotic device of the present invention that shows its location relative to a model that contains only three teeth.

FIG. 4 is a representation of an orthotic device of the present invention from the perspective of the bottom of the first layer.

FIG. 5 is a representation of a close-up view of a cross-section of an orthotic device of the present invention.

### DETAILED DESCRIPTION OF THE INVENTION

Reference will now be made in detail to various embodiments of the present invention, examples of which are illustrated in the accompanying figures. In the following detailed description, numerous specific details are set forth in order to provide a thorough understanding of the present invention. However, unless otherwise indicated or implicit from context, the details are intended to be examples and should not be deemed to limit the scope of the invention in any way.

In one embodiment, the present invention comprises, consists essentially of or consists of an orthotic device that comprises a first layer, a second layer and an arched trapezium. The term layer is used to differentiate components of the device, and portions of the device that are part of the same layer are preferably contiguous. As persons of ordinary skill in the art will recognize, the term layer does not in and of itself connote a limitation as to size, shape or configuration.

The first two layers are configured in the shape of an arch that corresponds to a subject's lower or upper set of teeth, and together the first layer and the second layer form a dental guard. The dental guard arch follows a path that corresponds to the path from the rear teeth on one side of a subject's mouth along the tooth line to the rear teeth on the other side of the subject's mouth. In addition to having the approximate shape of an arch when viewed from the top or bottom, the first two layers are configured such that they form a dental guard that has a cross-section that forms a trough that protects the teeth and facilitates association with the teeth. The inner surface of the first layer forms the inner surface of the trough. The outer surface of the first layer is affixed to the inner surface of the second layer.

When the device is designed for the lower set of teeth and worn, the outer surface of the second layer is oriented upward, and the trough is oriented facing downward. When the device is designed for the upper set of teeth and worn, the reverse is true, and the outer surface of the second layer of the dental guard is oriented downward, whereas the trough is oriented upward.

The first layer is what enables the orthotic to retain its position in the mouth of user. It is made of a cushioning material that both can be compressed, and to a sufficient degree resist compression. Accordingly, it is configured to have an inner surface that when in use is proximate to and contacts at least some of the user's teeth and maintains association by exerting a mechanical force on at least the infrabulge of the teeth that it receives. The force may, for example, simultaneously be exerted on the buccal side and the lingual side of the user's teeth.

In some embodiments, preferably some, most (e.g., at least 50%, at least 60%, at least 70%, at least 80%, at least 90%, or at least 95%) or all of the inner surface of the first layer of the dental guard physically touches a user's teeth and/or gums. Thus, the inner surface of the first layer may be molded or contoured to receive to the lower or the upper set of teeth of a particular user. Preferably, the inner surface forms an irregular trough that has a shape that is configured to receive the specific user's teeth. However, it is also within the scope of various embodiments of the present invention that the first layer is not configured for a particular user. Instead, it may be part of a device that is of a size that is common to many different users, and thus, many different users could wear, provided that the first layer comprises, consists essentially of or consists of a material that is sufficiently compressible to be used by a plurality of users with different size teeth while it is also able to provide sufficient resistance to compression to allow the device to be held in place. As long as a device causes sufficient retention by a user, it may in some embodiments, have one or more locations where it does not associate with one or more teeth. Thus, by way of a non-limiting example, in some embodiments, the inner surface of the first layer may be smooth and of a uniform or non-uniform thickness. In some embodiments, the first layer is between 0.5 mm and 1 5 mm thick.

As noted above, the first layer may comprise, consist essentially of or consist of a cushioning material. This cushioning material is preferably capable of engaging the infrabulge of at least a plurality, at least a majority or all of the teeth of either the upper set of teeth or lower set of teeth by mechanical retention. As persons of ordinary skill in the art are aware, mechanical retention refers to a physical force between two objects that cause them to remain in place. In some embodiments, the first layer comprises, consists essentially of or consists of ethyl vinyl acetate, which is a co-polymer of ethylene and vinyl acetate. Thus, the ethyl vinyl acetate may form a liner that renders the first layer retentive on a plurality of teeth.

The second layer is located adjacent to the first layer and covers the surface of the first layer that does not come into contact with a user's teeth or gums. Thus, it forms a protective layer (also referred to as a coating) on that surface, but not on the inner surface of the first layer. Because the first layer forms a trough, in addition to the inner surface that comes into contact with teeth and gums and an outer surface that is coated by a second layer, there is also a small edge between those two surfaces. Optionally, the second layer extends to cover that edge, but in some embodiments it does not cover that edge. The second layer is preferably bonded to the first layer through chemical bonds. Each of the outer surface of the first layer and the inner surface of the second layer may independently be smooth or regularly or irregularly contoured. Methods for forming dental guards in which a plastic coating covers a cushioning material are well-known in the art. By way of a non-limiting example, the dental guard portion of the present invention may comprise, consist essentially of or consist of two layers: a soft inner layer (a first layer) of ethyl vinyl acetate and a hard second layer of styrene butadiene copolymer, each of 1-2 mm in thickness, e.g., each layer being approximately 1.5 mm thick. Dental guard portions of the devices of the present invention (without the arched trapezium) may be obtained from commercial sources such as from Dreamgard, Inc. of Eden Praire, Minn. Glidewell Laboratories of Newport Beach, Calif. and Dentsply of York, Pa.

In some embodiments, the second layer is present over and protects the entire outer surface of the first layer or at least 60%, at least 70%, at least 80%, at least 90% or at least 95% of the outer surface of the first layer. By way of a non-limiting example, the second layer may comprise, consists essentially of or consist of a hard material such as polyethylene.

The outer surface of the first layer and the outer surface of the second layer may each independently be smooth or regularly or irregularly contoured. When the outer surface of the first layer is smooth, the inner surface of the second layer may also be smooth, and when the outer surface of the first layer is not smooth, preferably, the inner surface of the second layer is also not smooth. Additionally, wherever the second layer coats the first layer, preferably there are no spaces between the two layers. Furthermore, the outer surface of the second layer may be smooth or regularly or irregularly contoured. By way of non-limiting examples, the first layer as measured from its inner surface to its outer surface may be 1 mm to 5 mm or 2 mm to 4 mm thick, and the second layer as measured from its inner surface to its outer surface may be 1 mm to 5 mm, 2 mm to 4 or 2 to 3 mm thick.

In addition to the first layer and the second layer, which form the dental guard, there is at least one and preferably are two blocks or more than two blocks that are e.g., chemically welded or otherwise affixed to the second layer. Each block may be any regular or irregular shape that has an overall height, width and length. When there are two blocks, they may or may not be minor images of each other.

In some embodiments, each individual block is not symmetrical along its axis between the buccal and lingual sides and is not symmetrical along its horizontal plane between its upper and lower halves. However, its front half may or may not be symmetrical to its rear half.

In one embodiment, each block is in the form of an arched trapezium, and the second layer forms a platform for the arched trapezium. Thus, the arched trapezium may be a six sided object that forms a block. The base of each block, which may also be referred to as a narrow side or narrowed end, may be fused to a region of the second layer and is smaller than the opposite side, which way be referred to as the wide side or wide end.

In some embodiments all sides of the block are flat. In other embodiments, one, two, three, four or five sides are flat. In some embodiments, one, two, three, four or five sides are not flat, and for example, they may independently form a regular or irregular concave or convex surface that is smooth or contoured or a combination thereof. Additionally, at corners or edges, there may be rounding of sides that abut or there may be an absence of rounding such that each side forms a plane and a consistent angle between sides is maintained until they meet at an edge. When a side is not flat, preferably the difference in the height from the lower point of the surface to the highest point of the surface is less than 3 millimeters.

In addition to the base, there is a first side that is perpendicular or substantially perpendicular to the base, a second side that is perpendicular or substantially perpendicular to the base and that has an edge in common with the base and an edge in common with the first side. As used herein an “edge” is where two sides of a block meet, and at an edge, unless otherwise specified, the planes of two sides may form any angle. Further, there may or may not be rounding at an edge.

There is also a third side that is perpendicular or substantially perpendicular to the base. The third side forms an edge with the second side and another edge with the base. As used herein, the phrase “substantially perpendicular” refers to between 80° and 100°, e.g., less than 10 degrees from being perpendicular in either direction or less than 8 degrees from being perpendicular in either direction or less than 6 degrees from being perpendicular in either direction or less than 4 degrees from being perpendicular in either direction or less than 2 degrees from being perpendicular in either direction or less than 1 degree from being perpendicular in either direction.

In some embodiments, the first side and the third side are parallel or substantially parallel, e.g., less than 10 degrees from being parallel, less than 8 degrees from being parallel, less than 6 degrees from being parallel, less than 4 degrees from being parallel, less than 2 degrees from being parallel, or less than 1 degree from being parallel. The first side may also be referred to as a rear side because when the block is part of the device, it is oriented toward the rear of a subject's mouth. Similarly, the third side may also be referred to as a front side because it is oriented toward the front of a subject's mouth.

The second side, which may be referred to as a buccal side, has opposite edges that are formed with each of the first side and the third side. The front side, the buccal side and the base may all meet at right angles to form corners of 90 degrees between each two sides or meet at rounded right angle, such that at the places where they meet, the angle between the sides is not 90 degrees, but the planes of their sides excluding the rounding areas are ninety degrees relative to each other. Similarly, the rear side, the buccal side and the base may meet to form corners of 90 degrees between each two sides or at rounded right angles. As persons of ordinary skill in the art are aware, due to normal usage, the edges of the arched trapezium will wear and even if the sides start as strict right angles, the sides may become rounded. Additionally, when sides are not perpendicular, but are substantially perpendicular, each set of sides that forms edges as described in this paragraph may form angles between 80 degrees and 100 degrees, 80 degrees and 90 degrees, 82 degrees and 90 degrees, 84 degrees and 90 degrees, 86 degrees and 90 degrees, 90 degrees and 100 degrees, 90 degrees and 98 degrees, 90 degrees and 96 degrees, 90 degrees and 94 degrees and 90 degrees and 92 degrees.

The fourth side, which may be referred to as a lingual side, of the arched trapezium will abut the first and third sides at opposite edges and slope away from the base toward a top side of the arched trapezium. The top side made also be referred to as the wide end or wide face. Because the fourth side slopes away from the base of the arched trapezium, the top side of the arched trapezium is larger than the bottom side, and the fourth side (lingual side) will typically have more surface area than the second side (buccal side). In some embodiments, the top side is perpendicular or substantially perpendicular to each of the first side, the second side and the third side such that the entire difference in size between the top side and the bottom side corresponds to the extension of the top side into the inner cavity of a user's mouth beyond the base. In other embodiments, at least 75%, at least 80%, at least 85%, at least 90% or at least 95% of the difference in sizes between the top side and the bottom side of the arched trapezium corresponds to the extension of the top side into the inner cavity of a user's mouth beyond the base. The use of the denotation of “top side” refers to the side of the block distal to the dental guard regardless of whether the device is used on the upper or lower teeth. Similarly, the denotation of the “bottom side” refers to the side of the block that is proximate to the dental guard.

In some embodiments, any horizontal cross-section of a block has a uniform width from the buccal side to the lingual side. In other embodiments, one or more horizontal cross-sections of a block has a non-uniform width from the buccal side to the lingual side.

The angle formed by the edge between the base and the lingual side of the device (as measured by a cross-section of the device) may be between 92 and 120 degrees, between 95 and 115 degrees or between 100 and 110 degrees.

In some embodiments, each block follows the part of the dental guard over or under a region of a user's teeth to which it corresponds. However, the same or different sized blocks may span different combinations of teeth, e.g., molars and pre-molars.

The devices of the present invention may be used by persons of many different ages, and these persons may have different sizes of teeth. Furthermore, due to differences in their stages of development they may have different numbers of teeth and different combinations of baby teeth and adult teeth, as well as one or more gaps in teeth, due to, e.g., a baby tooth's having fallen out and an adult tooth only having partially replaced it or not begun to replace it. Thus, in some embodiments, each arched trapezium is long enough to cover the length of the first premolar, the second premolar, the first molar and the second molar, wherein the length of the tooth refers to the dimension of the molar or premolar that runs between consecutive teeth. In other embodiments, each arched trapezium is long enough to cover the length the second premolar, the first molar and the second molar, wherein the length of the tooth refers to the dimension of the molar or premolar that runs between consecutive teeth. In still other embodiments, each arched trapezium is long enough to cover the length of the first premolar, the second premolar, and the first molar, wherein the length of the tooth refers to the dimension of the molar or premolar that runs between consecutive teeth. In still other embodiments, each arched trapezium spans from the first premolar to the second molar, wherein the length of the tooth refers to the dimension of the molar or premolar that runs between consecutive teeth, and either one or both of the second premolar and the first molar are missing or have not grown in or have only partially grown in. When an arched trapezium covers a tooth or spans from one tooth to another, it may run the entire length of all of the recited teeth or for the first and/or last recited tooth, the arched trapezium spans less than 90%, less than 80%, less than 70%, less than 60%, less than 50%, less than 40%, less than 30%, less than 20% or less than 10% of the length of that tooth. Additionally, in some embodiments, the arched trapezium does not cover any portion of any teeth other than the first premolar, the second premolar, the first molar and the second molar or other than the first premolar, the second premolar, and the first molar or other than the second premolar, the first molar and the second molar.

As noted above, the block itself may be flat on all sides or curved over one, both or neither of the lingual or buccal sides, and for example, have a concave or convex surface over those sides, respectively. Thus, the face of each of the sides and the top and bottom may independently be flat or regularly or irregularly contoured. For example, the top surface may be contoured to receive teeth that will contact it when in use. The location of contact of those teeth is the occlusal surface. By way of another example, the fourth side (lingual side) may be flat or it may contain a concave surface.

The arched trapezium is designed to provide resistance to users when they try to bite down. Thus, it is to be made of a material that is sufficiently resistant to compression under the force of a user's bite. In some embodiments, this resistance is at least the resistance of poly methyl-methacrylate (“PMM,” which is also referred to as “PMMA”).

In some embodiments, each block is made of a material that can be sculpted. Thus, it can be modified in the vertical direction by one or more of addition, subtraction or contouring. Sculpting of modifying may be advantageous if a block becomes damaged or wears or a user's needs change. By way of a non-limiting example, sculpting can be through the use of a scalpel and/or laser. In some embodiments, the result of sculpting is a flat surface, a rounded surface, a regular patterned surface, an irregular patterned surface or a contour that is configured to receive the occluding surface of upper or lower teeth (the teeth on the side that does not hold the device). Thus, on the upper side of a block (the occlusal surface), there may be a plurality of convex and concave regions that in whole or in part are designed to receive teeth.

The composition of the arched trapezium will help to define its durability, and in some embodiments, the arched trapezium may comprise, consist essentially of or consist of a thermoplastic material such as PMM in the form of an acrylic block. Because the device will be used in the oral cavity, preferably the thermoplastic does not contain bisphenol-A. PMM is particularly useful because depending on the grade, its glass transition temperature is typically between 85° C. and 165° C. Thus, it can be molded by injection molding, compression molding, extrusion, and cell casting. Additionally, it can be welded to other materials using commercially available cements such as cyanoacrylate cement or by using solvents such as di- or trichloromethane. Preferably, when PMM is used, the PMM is a medical grade, which is available from commercial sources. Among the benefits of PMM and similar materials, are that they can be adjusted and polished. Additionally, PMM can be colored through the use of dyes in order to satisfy aesthetic choices. In order to introduce color, the coloring material, e.g., the dye, may be dropped into a liquid monomer portion precursor of PMM before or as the monomer is mixed with a powder portion precursor of the PMM. As the liquid and powder polymerize through a chemical reaction, the dye is dispersed and becomes part of the polymerized product, thereby imparting color to the polymerized product.

As noted above, the PMM may be in the form of a block and is chemically affixed to the second layer by heating and cooling the PMM and optionally introducing a cement or glue. PMM and other compositions that may be used to form the block are preferably selected at least in part because they can withstand the forces manifested by persons afflicted with neuro-psychological disorders such as Tourette Syndrome and Chronic Tic Disorder.

In many embodiments, the orthotic will have two arched trapeziums. When there are two arched trapeziums, one may be referred to as a first arched trapezium and the other may be referred to as a second arched trapezium. Each of these may be in the form of a block that has a narrow end and a wide end, wherein the narrow end is fused to the second layer.

When there are two arched trapeziums, the first arched trapezium may span from a location on the second layer that corresponds to a right second molar to a location on the second layer that corresponds to a right first premolar, and the second arched trapezium may span from a location on the second layer that corresponds to a left second molar to a location on the second layer that corresponds to a left first premolar. For convenience when referring to specific teeth, the reference is to the teeth within the device and not on the occlusal surface.

In some embodiments, the first arched trapezium has its greatest width (from buccal side to lingual side) that is narrower than the width of the dental guard at the first premolar and the second arched trapezium has a greatest width that is narrower than the width of the dental guard at the first premolar.

The desired height of the arched trapezium may be determined by the size of the oral cavity of the person who will use it. In some embodiments the block has a height of at least 4 mm By way of non-limiting examples, the height may be 4-12 mm or 4-10 mm or 4-8 mm or 5-8 mm or 6-8 mm In some embodiments the block has a length of 1-5 cm, or 2-4 cm.

In some embodiments the block has a greatest width of 3 mm to 10 mm or 4 to 7 mm In many embodiments, the width of the block is not uniform, and preferably, the largest width is no more than 40% greater or no more than 30% greater than the narrowest width but is at least 10% or at least 20% wider than the narrowest width. In one embodiment each of the first block and the second block has a widest width of at least 4 mm, e.g., 4-10 mm, 5-9 mm or 6-8 mm and a narrowest width of 3-8 mm, 3-6 mm, 4-6 mm or 4-5 mm

The device may be designed such that it is able to retain its shape when removed from a user's mouth. Because the inner surface of the first layer is designed to cause association with the teeth through physical forces, its trough may be slightly smaller when the device is outside of the mouth, but the cavity of the trough would be forced wider by placement on the teeth within it.

The design of the first and second layers may be determined based on well-known techniques for taking impressions of the lower or upper set of teeth of a person. When designing a block (or blocks), a healthcare provider may prescribe each block's size and shape based on a particular measured bite and/or consideration of the nature and frequency of undesirable movements when a user's mouth is opened to different sizes. If at any time a healthcare provider determines that the size or shape of a block needs to be changed, the change can easily be accomplished by adding or subtracting PMM. By way of example, a PMM arched trapezoid acrylic block may be fabricated and shaped under 10 psi to 25 psi (e.g., 20 psi) at 100 to 180° F. (e.g., 150° F. approximately 65.56 ° C.) for 5-15 minutes.

By way of further example, one may adjust the arched trapezoid acrylic block to fit the arch of the patient's lower jaw even after a block is affixed to a dental guard. As noted above, the blocks of the present invention may be formed from, consist, consist essentially of or comprise a thermoplastic material. Thus, in some embodiments, the thermoplastic material is the only or is essentially the only component of the block. Therefore, in order to increase the size of the block, external thermoplastic may need to be introduced.

As noted above, the vertical dimension may be adjusted such that the inter-occlusal space is a prescribed distance based on a clinical examination that determines the lower jaw position. After this measurement is taken, the arched trapezium acrylic block may be chemically fused to the second layer in an orientation such that the wider of two opposing sides of different sizes has the potential to touch the opposing dentition when a user's mouth is closed. Thus, the narrower part (the bottom) is fused to the base.

One of the benefits of an arched trapezium design is that it allows more room for the tongue, and it has the ability to allow for better linguistics while a person wears the orthotic. Further, the recessed design of the lingual portion of the trapezium prevents tongue biting. The buccal portion of the arched trapezium may be sized and thus designed not to interfere with the neutral zone between the cheek and tongue, while still providing support to the buccinator muscle and designed to protect or avoid cheek biting. In some embodiments, preferably the buccal side of the block does not extend horizontally beyond the first and second layers and is flat, concave or convex.

As noted above, when creating a device of the present invention, a healthcare professional may first take an impression of a patient's mouth in order to create the contouring of the patient's teeth and to define the first layer of the dental guard. Typically, a patient will wear the device of the present invention on his or her lower jaw, in which case the impression of the complete lower set of teeth is recommended. Alternatively, the patient will wear the device on the upper set of teeth, in which case the impression of that complete set of teeth is recommended. The healthcare professional will then determine the span of the patient's jaw when opened widest, and the comfort level with a space of varying heights, e.g. beginning at 4 mm.

With this information, one can create the dental guard portion of the device, which corresponds to the first and second layers. Then one can chemically weld block of e.g., PMM to the second layer at the appropriate locations, which, for example, may correspond to the left premolars to left molars and right premolars to right molars.

Through the use of the present invention, one may eliminate or reduce symptoms of certain neurological and neuro-psychological disorders. In some embodiments, by changing the alignment of TMJs the frequency and/or intensity of these symptoms may change. Thus, a subject may insert the device in his or her mouth and position it over the correct set of teeth and bite down or up. The occlusion surface from the opposite set of teeth will move no further than the block or blocks allow. This will limit the movement of the TMJ and prevent certain signals from being sent to the brain. Prevention of these signals from being sent will decrease the intensity and/or frequency of certain involuntary movements.

The aforementioned devices describe that the block is in the form of an arched trapezium. For many users, this is preferable for the uses described above. However, the inventor has also appreciated that PMM is a particularly useful product, and an orthotic device can be created in which PMM is not in the form of an arched trapezium. For example, it may be in the form of a block that is symmetrical left to right, front to back and top to bottom or have another regular or irregular configuration. These blocks may be used with, for example, dental guards that are configured to retain association with a subject's upper or lower teeth, and each block may be situated at a position of a dental guard that corresponds to the space from a second molar and first premolar.

Various embodiments of the present invention may be further illustrated by reference to the accompanying figures. In these figures, for illustrative purposes, various elements are not necessarily drawn to scale.

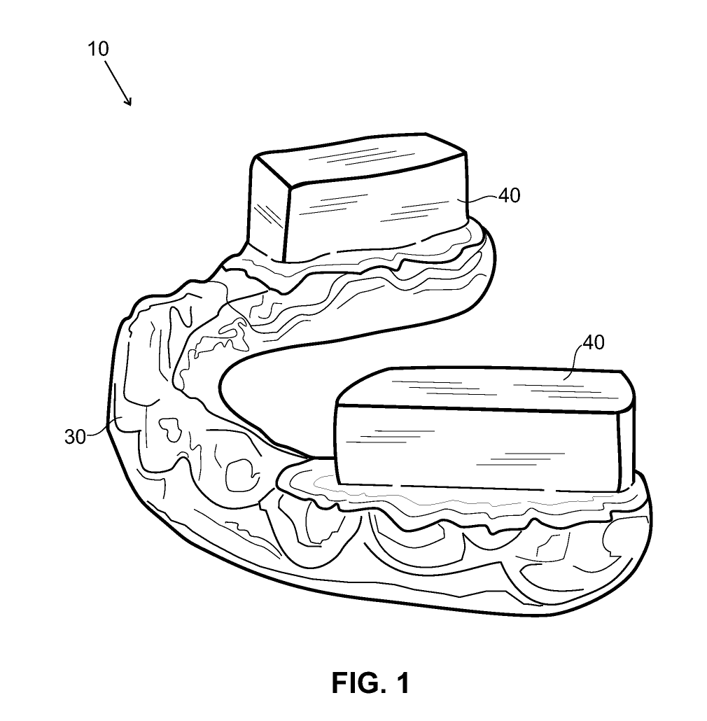

FIG. 1 is an orthotic device 10 of the present invention. The first layer, not shown, is what comes in contact with a user's teeth. A second layer 30 of the dental guard covers the first layer and on it sits two blocks 40. The base of the blocks is show as extending over a portion of the second layer, which is a by-product of chemical fusing. As shown, the second layer of the dental guard is not smooth.

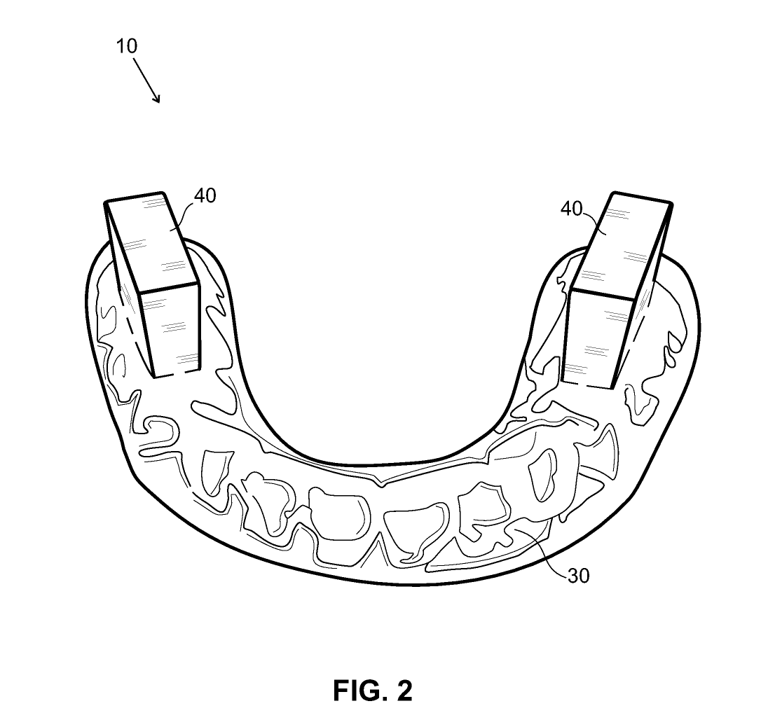

FIG. 2 shows the same device 10 from a different angle. The blocks 40 can be seen as arched trapeziums sitting on the second layer 30. The blocks have larger top surfaces than bottom surfaces, and consequently even though they have outer walls that are perpendicular to the top plane of the dental guard, the inner (lingual) sides are angled.

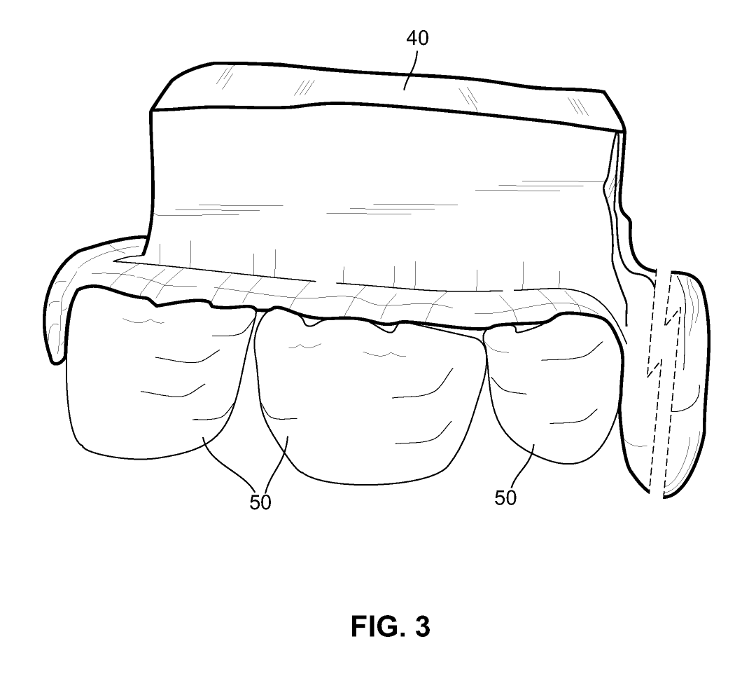

FIG. 3 shows a close-up of a model of a block 40. To emphasize the location of the block, relative to the teeth, only three teeth 50 are shown. Further, for illustrative purposes and to show the location of the teeth, only a portion of the dental guard, which contains both the first layer and the second layer, is shown. As persons of ordinary skill in the art will appreciate and as is implied by the right side of the figure, in a person's oral cavity there are teeth mesial to what is shown.

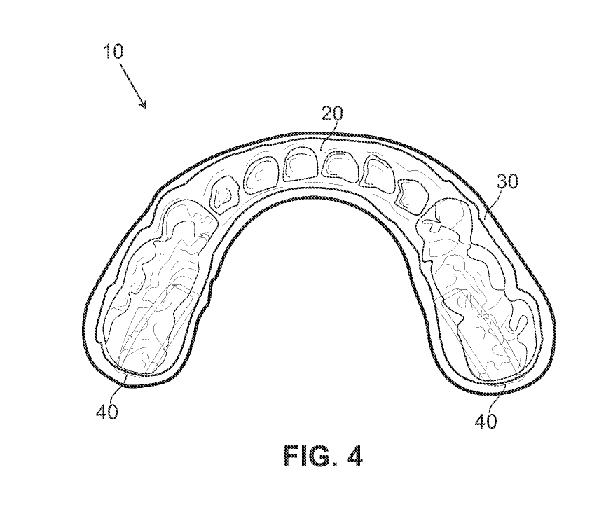

FIG. 4 illustrates the trough of the device 10 as viewed from the bottom of a device for the lower set of teeth. Because one is looking from the bottom of the device for the lower set of teeth, one sees an edge of the trough where the first layer 20 meets the second layer 30. The blocks 40 would be obscured from view but are illustrated in the figure to show their relative placement.

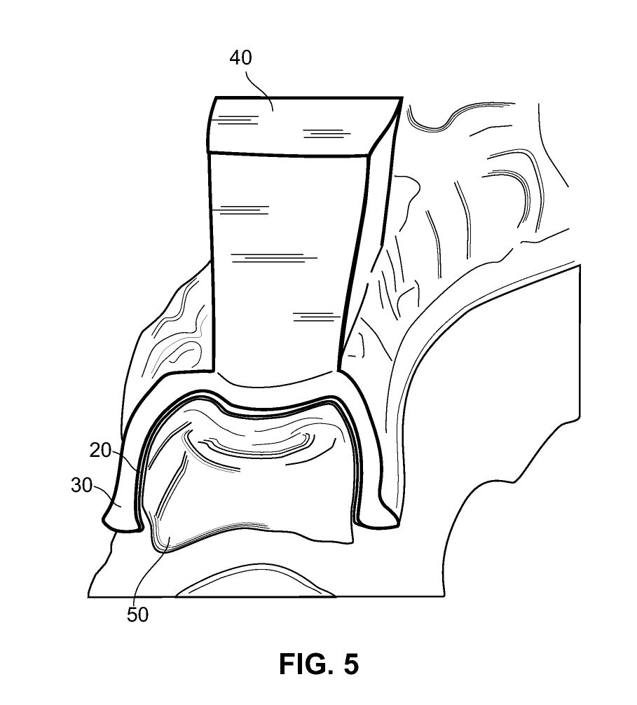

FIG. 5 shows a cross-section of a device. The first layer 20 sits along the inner surface of the second layer 30. Block 40 sits on top of the dental guard and the lingual side is angled whereas the buccal side is perpendicular to the base. Within the trough is a tooth 50.

Unless otherwise specified or implicit from context, any of the features of the various embodiments described herein can be used in conjunction with features described in connection with any other embodiments disclosed. Thus, features described in connection with the various or specific embodiments are not to be construed as not suitable in connection with other embodiments disclosed herein unless such exclusivity is explicitly stated or implicit from context.

1. An orthotic device comprising:
(a) a first layer, wherein the first layer comprises a cushioning material and is configured to engage the infrabulge of a plurality of teeth of one of an upper set of teeth or a lower set of teeth by mechanical retention;
(b) a second layer, wherein the second layer forms a protective coating and is chemically bonded to the first layer; and
(c) an arched trapezium, wherein the second layer forms a platform for the arched trapezium, wherein the arched trapezium has a top side, a bottom side, a buccal side, and a lingual side, wherein the top side is larger than the bottom side, the arched trapezium is not symmetrical between the buccal side and the lingual side, and the lingual side slopes away from the bottom side to the top side, and further wherein the top side is capable of touching a user's dentition opposite the infrabulge when the user wears the device.

2. The orthotic device of claim 1, wherein the arched trapezium comprises poly methyl-methacrylate.

3. The orthotic device of claim 2, wherein the first layer comprises ethyl vinyl acetate, wherein the ethyl vinyl acetate forms a liner that renders the first layer retentive on said plurality of teeth.

4. The orthotic device of claim 3, wherein the second layer comprises polyethylene.

5. The orthotic device of claim 2, wherein the poly methyl-methacrylate is in the form of a block and is chemically associated with the second layer.

6. The orthotic device of claim 5, wherein the buccal side is perpendicular to the top side and the top side is smooth.

7. The orthotic device of claim 6, wherein the arched trapezium is a first arched trapezium that is in the form of a first block and the device further comprises a second arched trapezium and the second arched trapezium is in the form of a second block, wherein the second block has a top side and a bottom side, wherein the bottom side is fused to the second layer and the top side is distal to the second layer, the top side is larger than the bottom side, and the second arched trapezium comprises polymethyl-methacrylate.

8. The orthotic device of claim 7, wherein the first arched trapezium spans from a location on the second layer that corresponds to a right second molar to a location on the second layer that corresponds to a right first premolar and the second arched trapezium spans from a location on the second layer that corresponds to a left second molar to a location on the second layer that corresponds to a left first premolar.

9. The orthotic device of claim 7, wherein the first arched trapezium spans from a location on the second layer that corresponds to a right second molar to a location on the second layer that corresponds to a right second premolar and the second arched trapezium spans from a location on the second layer that corresponds to a left second molar to a location on the second layer that corresponds to a left second premolar.

10. The orthotic device of claim 5, wherein the block has a height of at least 4 mm.

11. The orthotic device of claim 7, wherein each of the first block and the second block has a height of at least 4 mm.

12. The orthotic device of claim 1, wherein the arched trapezium is in the form of a block and is made of a material that is capable of being sculpted.

13. The orthotic device of claim 12, wherein the top side of the block is contoured to receive teeth.

14. The orthotic device of claim 13, wherein the block is comprised of poly methyl-methacrylate.

15. The orthotic device of claim 7, wherein there is a plane of symmetry between a front half and a back half of each of the first block and the second block.

16. The orthotic device of claim 15, wherein the top side of the first block is at least 10% larger than the bottom side of the first block.

17. The orthotic device of claim 16, wherein the top side of the second block is at least 10% larger than the bottom side of the second block.

18. The orthotic device of claim 15, wherein each of the first block and the second block has a widest width of at 4-10 mm.

19. The orthotic device of claim 18, wherein each of the first block and the second block is made of PMM and has a height of at least 4 mm.

20. The orthotic device of claim 19, wherein the first layer of the orthotic device comprises ethyl vinyl acetate and the second layer of the orthotic device comprises polyethylene.
